(19) United States
(12) Patent Application Publication
(10) Pub. No.: US 2006/0048047 A1
(43) Pub. Date: Mar. 2, 2006

(54) Online annotation management system and method

(76) Inventor: Peng Tao, Santa Clara, CA (US)

Correspondence Address: FORTUNE LAW GROUP LLP, 100 CENTURY CENTER COURT, SUITE 315, SAN JOSE, CA, 95112, US

(21) Appl. No.: 11/215,547

(22) Filed: Aug. 29, 2005

Related U.S. Application Data
(60) Provisional application No. 60/605,060, filed on Aug. 27, 2004.

(51) Int. Cl. G06F 17/24

(52) U.S. Cl. 715/512

(57) ABSTRACT

An online annotation management system and method for creating annotations while browsing a web resource and managing the annotation information associated with corresponding web resources is disclosed. A computer-implemented method for enabling users to create annotations during an online session includes the steps of providing a switch module operable to enable the user to switch between a browsing mode and an annotation mode, and providing an annotation module operable to enable the user to annotate a resource being viewed. The annotated content created by the user is preferably stored in a private manner. The annotated content may be shared by the user with at least one peer if the user so desires.

### CROSS REFERENCE TO RELATED APPLICATIONS

The present application claims priority under 35 U.S.C. 119(e) from provisional patent application Ser. No. 60/605,060, entitled “Personal Online Annotation Management System”, filed on Aug. 27, 2004, the disclosure of which is herein incorporated by reference in its entirety.

### FIELD OF THE INVENTION

The present invention generally relates to systems and methods that enable end-users to make annotations such as comments and notes associated with online resources during their online activities, and more particularly relates to an online annotation management system and method for creating annotations while browsing a web resource and managing the annotation information associated with corresponding web resources.

### BACKGROUND OF THE INVENTION

While reading, many readers like to use a pen or other marker to mark interesting content of what they are reading and write down comments and/or notes related to the content. While online, many end-users would like to make similar marks and comments and/or notes. These online end-users would like to have a tool to easily mark the interesting content and insert annotations, such as comments and notes, into the content while they are browsing web resources online. Furthermore, online end-users also wish to have a management system to help them manage, update, and retrieve the marked contents and associated annotations for their own purposes. Additionally, online end-users also expect that the system will help them to share their comments/notes with friends, or post them publicly, and provide them some personalized help such as translation while they are making the annotations while browsing online.

Presently, there exists no such product or system or method to achieve the above functionalities for online end-users. One prior art solution, A9.com, available from Amazon.com, provides a simple function for its registered users which enables the writing of a note about the page the user visited and displays the notes when the user returns to the web page. This solution is too simplistic in functionality and does not achieve the functions listed above. FIG. 1 shows a user interface example of A9.com's online diary writing tool having a pad 101 embedded inside the tool that a user may use to input his annotations for the whole web page. A9.com does not provide for an annotation tool.

Certain collaborative annotation/discussion systems to help a user make annotations publicly on web pages are known in the prior art. Annotea is one open source project that enables the end-user to insert annotations in a web page while the end-user is using a Mozilla browser. Microsoft also provides a discussion feature in it's Internet Explorer browser. Simultaneously, there is ongoing research in the area. The major goal of these projects, products, and research is to make the web more interactive to end-users, particularly to members of collaborative groups. In other words, these systems, methods, and processes enable the end-users (1) to publish their comments on the web site and (2) to share with members within a group served by the annotation/discussion server. These systems, methods, and processes are web page or discussion group oriented and are designed for discussion, not for the users to write a personal diary or make, edit, or retrieve their own annotations privately. FIG. 2 and FIG. 3 show user interfaces of the Annotea browser and the Microsoft discussion feature in Internet Explorer, respectively. With particular reference to FIG. 3, the inoperability of all discussion buttons 301 and the presence of error message 302 shows the unnecessary trouble experienced by Microsoft users of the discussion feature. As shown server support for the service is not available.

Annotea is a W3C LEAD (Live Early Adoption and Demonstration) project under Semantic Web Advanced Development (SWAD). Annotea enhances collaboration via shared metadata based web annotations, bookmarks, and their combinations. However, the system has several limitations. Firstly, Annotea is not designed for personal use, and the users of the system cannot make/edit private annotations. Secondly, the users of the system cannot choose the people with whom they share their annotations, as Annotea forces the users to share the annotation with the whole group using the system. Finally, Annotea does not provide and manage personalized referential services such as the provision of dictionary/thesaurus lookup, specific language translation, and help in tracking the referential services.

Conventional annotation/discussion servers do not enable the user to create and edit annotations privately, that is, for the user's personal use. Nor do conventional annotation/discussion servers enable the user to share his annotation with groups of people selected by the user, which may be different from the group served by the annotation/discussion server.

What is needed is an online annotation management system and method that allows a user to create and edit annotations What is also needed is an online system and method that allows the user to save and retrieve the annotations privately via a personal annotation management system. What is further needed is an online system and method that provides the user with options including posting the annotation publicly and sharing the annotation with peers of the user's selection regardless of whether the peers are members of the groups served by an annotation/discussion server. What is also needed is an online system and method that provides the user with finer retrieval control via different criteria such as keywords in the annotation, keywords in the original content, keywords in any of the user's annotations, and keywords in the annotations shared with certain groups of people. What is further needed is an online system and method that enables the user to easily customize the tools he wishes to use during his browsing/annotation experience and to embed these tools into the personal annotation management system. What is also needed is an online system and method that provides the user with an optional anonymous publishing mechanism and with an optional anonymous communication mechanism.

### SUMMARY OF THE INVENTION

The present invention overcomes the disadvantages of the prior art by providing in exemplary embodiments, an online annotation management system and method for creating annotations while browsing a web resource and managing the annotation information associated with corresponding web resources. The online annotation system and method of the invention further provides that the end-user's annotations may be private by default and allow the end-user to create, edit, save, and retrieve an annotation record, while also enabling the user to publish the annotations publicly or to a selected group of the end-user's choosing.

In accordance with an aspect of the invention, a computer-implemented method for enabling users to create annotations during an online session includes the steps of providing a switch module operable to enable the user to switch between a browsing mode and an annotation mode, and providing an annotation module operable to enable the user to annotate a resource being viewed.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of design and to the sequence of steps and processes set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent methods and systems insofar as they do not depart from the spirit and scope of the present invention.

### BRIEF DESCRIPTION OF THE DRAWINGS

The present disclosure may be better understood and its numerous features and advantages made apparent to those skilled in the art by referencing the accompanying drawings.

FIG.1 is a screenshot showing a user interface of a prior art annotation system;

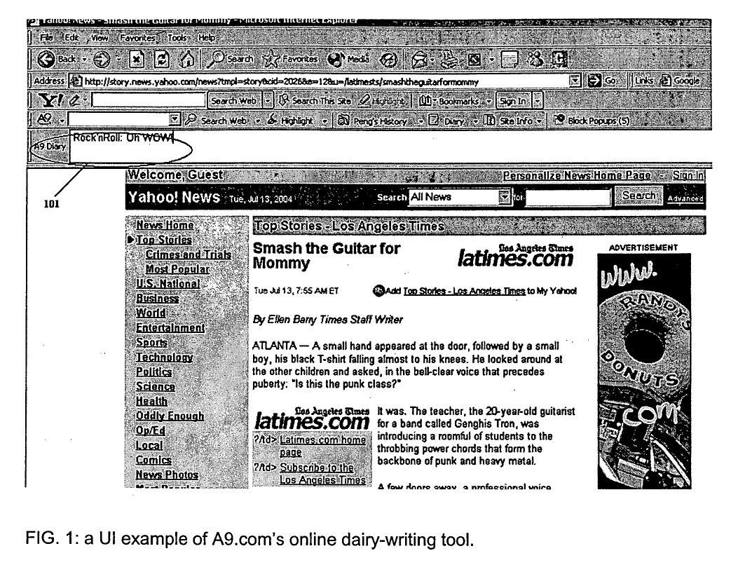

FIG. 2 is a screenshot showing a user interface of another prior art annotation system;

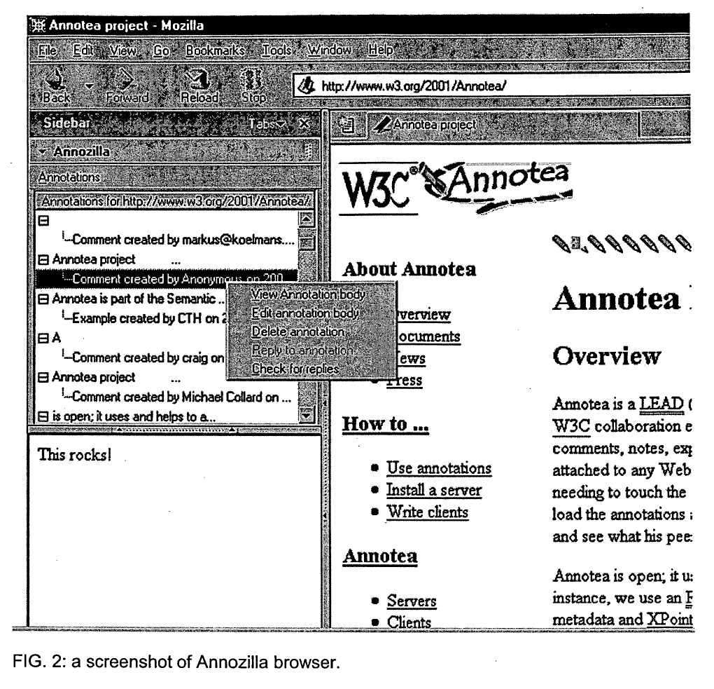

FIG. 3 is a screenshot showing a user interface of yet another prior art annotation system;

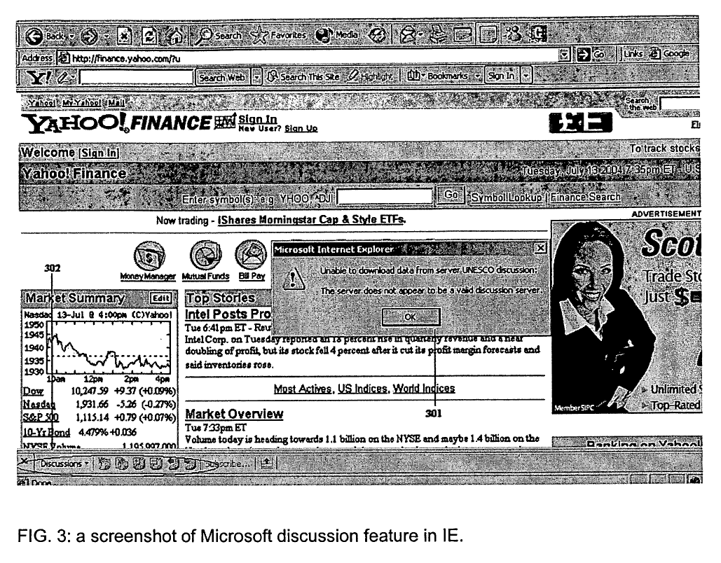

FIG. 4 is a schematic representation of a network environment in which the present invention may be practiced in accordance with the invention;

FIG. 5 is a schematic representation showing a switch module in accordance with the invention;

FIG. 6 is a screenshot showing a user interface in a browsing mode in accordance with the invention;

FIG. 7 is a screenshot showing a user interface in an annotation mode in accordance with the invention;

FIG. 8 is a screenshot showing a user interface including an exemplary annotation in accordance with the invention;

FIG. 9 is a screenshot showing a user interface including existing annotations in accordance with the invention;

FIG. 10 is a screenshot showing a user interface including annotations and comments in accordance with the invention;

FIG. 11 is a table showing a content-matching location object and an annotation content object in accordance with the invention;

FIG. 12 is a screenshot showing a user interface including the same annotations as shown in FIG. 8 and different editorial links and advertisement links in accordance with the invention;

FIG. 13 is a table showing a data structure for storing information concerning applications and a screen shot showing the use of one such application in accordance with the invention;

FIG. 14 is a schematic representation showing an annotation sharing process in accordance with the invention;

FIG. 15 is a flow chart showing a process of sending an invitation to view an annotated resource in accordance with the invention; and

FIG. 16 is a flow chart showing a process in which an invitee may view an annotated resource.

### DETAILED DESCRIPTION OF THE INVENTION

The present invention may be implemented using known computing devices and distributed networks. Certain features of the invention may be implemented in a server machine or distributed across a plurality of server machines. Methods in accordance with the present invention may be implemented in computer-readable media operable to instruct computing devices to perform method steps. Systems in accordance with the present invention may include computing devices operable to perform method steps.

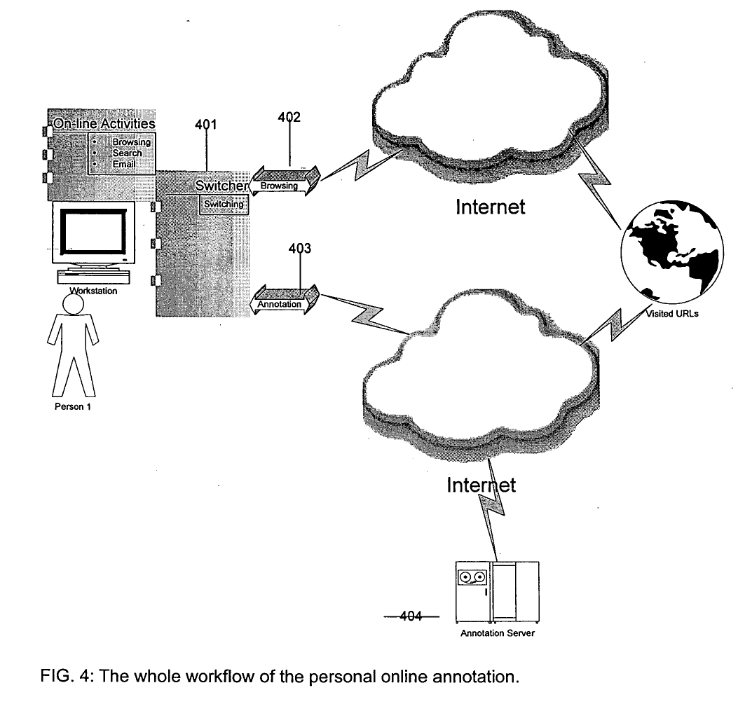

Referring to FIG. 4, the system and method of the invention may be implemented in a network environment. The online annotation management system may include a switch module 401 operable to switch between a browsing mode and an annotation mode. The switch module 401 may be used to help the end-user easily (by means of one click) switch between these two modes. In the browsing mode, the end-user may be directed through conventional browsing channels and protocols 402 to the Internet. In the annotation mode, an annotation module 403 may be called to enable the end-user to annotate a web resource or other document and to manage the annotations in an annotation server 404 coupled to the Internet.

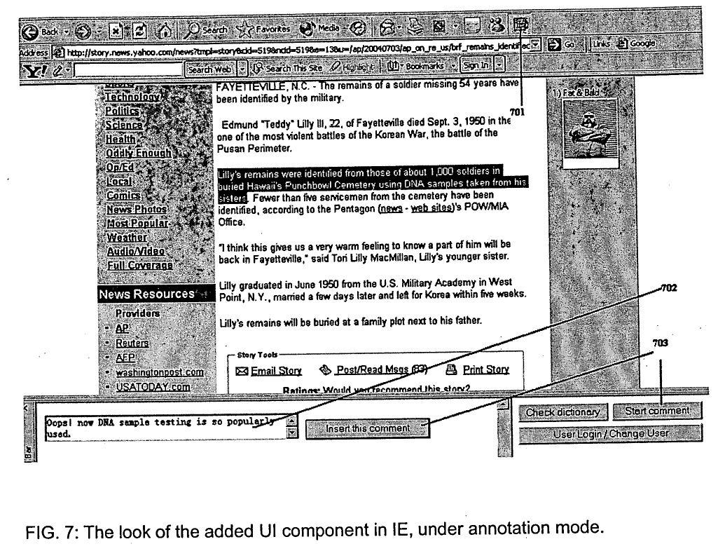

The switch module 401 may be accessed by the end-user by means of a button 701 (FIG. 7) disposed in a toolbar of a browser. By selecting the button 701 the annotation module 403 (FIG. 4) may be called to enable the end-user to create annotations including comments and notes, and update, retrieve, and manage the online annotations associated with corresponding web resources.

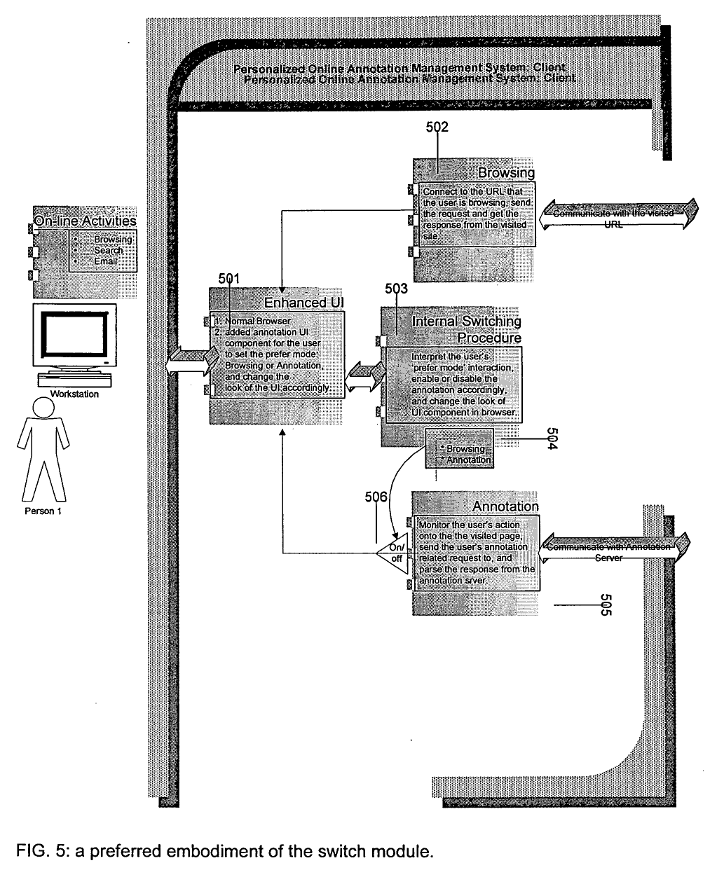

FIG. 5 illustrates a preferred embodiment of the switch module 401 including a user interface component 501, which may form an enhanced user interface and enable the end-user to change the look of the user interface component 501 to reflect the end-user's preferred status 504 which may include browsing mode or annotation modes. The user interface component 501 resides in the client side and may include a plug-in in the browser. The user interface component 501 may further include an internal procedure 503 for processing the end-user's interaction with the user interface component 501. The internal procedure 503 may be operable to change the user's preferred status 504 to browsing mode or annotation mode and enable and disable the annotation module 403 via an on/off switch 506. The internal procedure 503 may also be operable to change the look of the user interface component 501 on the client side. Regardless of whether the end-user is in browsing mode or annotation mode, the end-user will always be able to browse and browsing requests may be sent and responses returned via normal browsing channels and processes 502. When the annotation mode is selected by the end-user, the end-user's activity may be monitored, annotation requests may be sent, and responses may be returned from the annotation server 404 via annotation process 505.

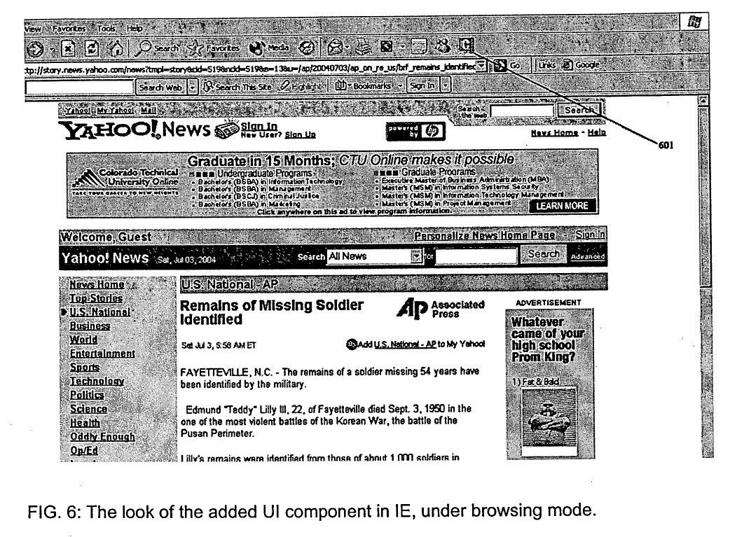

The user interface component 501 of the switch module 401 may be implemented as a button or a set of buttons in a toolbar or explorer bar inside a browser such as Internet Explorer, Netscape, and Mozilla. FIG. 6 and FIG. 7 illustrate different looks of the user interface component 501 implemented in Internet Explorer, in the browsing mode and the annotation mode respectively. In both annotation and browsing modes, a switch button 601 (FIG. 6) and a switch button 701 (FIG. 7) may be provided. When button 701 is depressed and set to the browsing mode, the look of the button 701 may change to the look of button 601 as shown in FIG. 6, and all of the end-user's commands will be processed as normal browsing commands. When the button 601 is pressed again and set to the annotation mode, it will look like button 701 as shown in FIG. 7. In the annotation mode, the user interface component 501 may include a start comment button 703, an input text field 702, and a pull-down menu (not shown).

In annotation mode, the end-user may perform any kind of online activity including online browsing, searching, shopping, banking, chatting and so on. However, unlike performing these activities in normal browsing mode, the end-user's online activity may be monitored by the annotation server 404 and the end-user's actions on the visited online resources, especially the annotation actions, may be tracked and recorded. The end-user may easily turn off the annotation mode by pressing button 701 in FIG. 7.

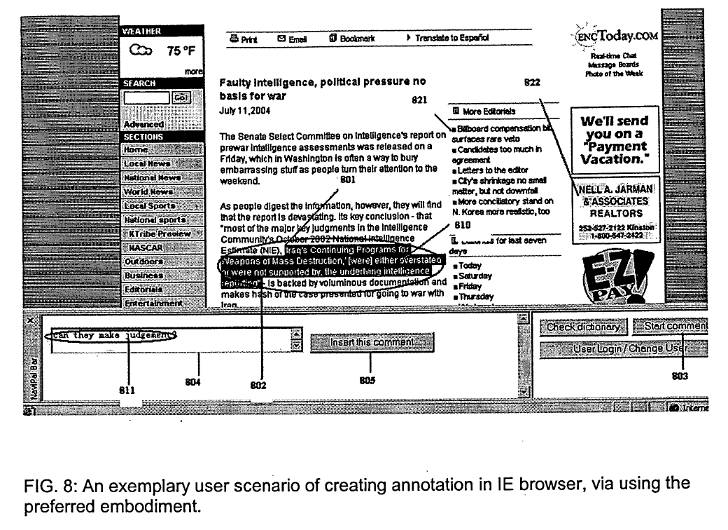

In annotation mode, the end-user may select and mark contents that the end-user is interested in when he visits the web resource and create annotations such as comments and notes associated with the parts of content selected and marked. The end-user may thereafter retrieve the annotations and update the annotations in a personalized manner. FIG. 8 shows an exemplary screenshot of an Internet Explorer browser window in which contents may be selected and annotations may be created in accordance with the systems and method of the invention. The end-user may move a mouse to the start position 801 of an interesting phrase 810, hold down the left-button of the mouse and move the mouse to an end position 802 of the interesting phrase to create a marked content. The marked content may then be displayed and the end-user may then click the start comment button 803 which may bring the input field 804 to the user interface component 501. The end-user may then fill out annotations 811 associated with the unit of marked content. Finally, the end-user may press an insert comment button 805 to insert the annotation.

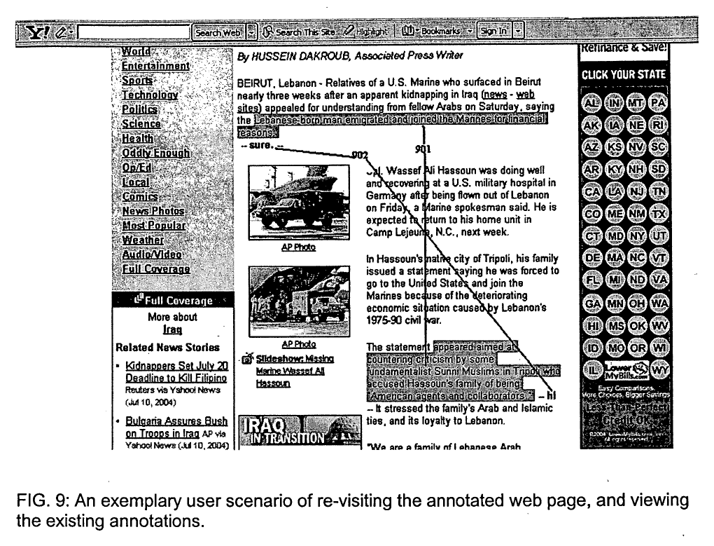

FIG. 9 shows an example in which an annotated web page is served by the annotation server 404. The served web page includes several units of marked content 901 and associated annotations 902. The look of the marked content 901 may be changed from an original look (as by using a different color highlight) to indicate that the marked content 901 is associated with the annotations 902. The end-user may also move the mouse inside the region of the marked content 901, activate an edit pad holding the annotations 902 associated with the marked content 901, and update or remove the annotations 902 shown on the edit pad. Original and updated annotations, and associated web resources, may be stored in the annotation server 404 for the purpose of retrieval, update, and management.

There are a variety of approaches to storing the annotations with the associated web resources. The simplest one is to store the whole web page at the annotation moment, which is in fact a snapshot of the web page at that moment, and the relative location information of the marked phrases. This is not a good method as it is neither cost-effective nor easily sharable. Assume the end-user retrieves the same URL at a future time, and the snapshot of the URL's full page is different as different sub-frames have been inserted into the URL, different ads have been placed in different places, and new discussion threads have been appended after the time of the first annotation. These changes result in a different snapshot of the same URL having the same main content. As such, the annotated page will be different and the annotation of the content may be stored separately in different pages, even though the annotations should be stored in the same annotated page.

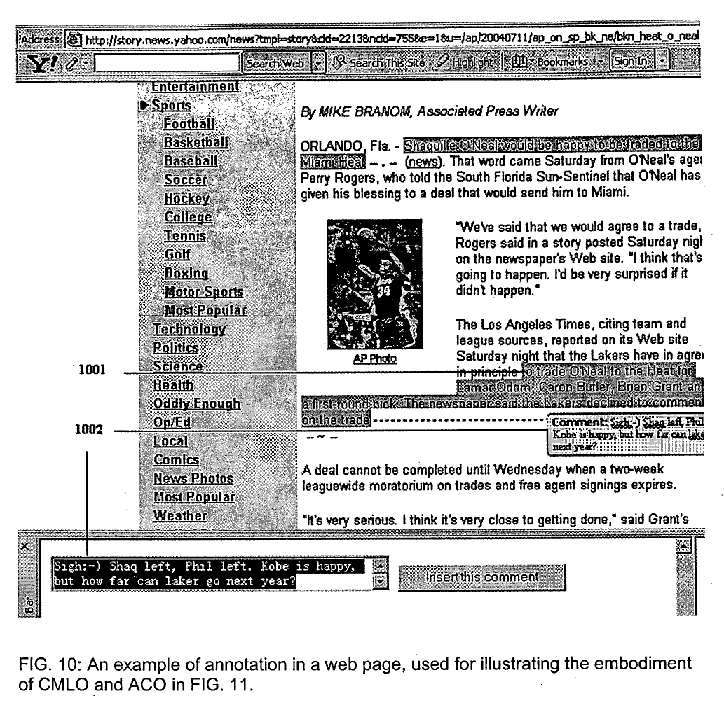

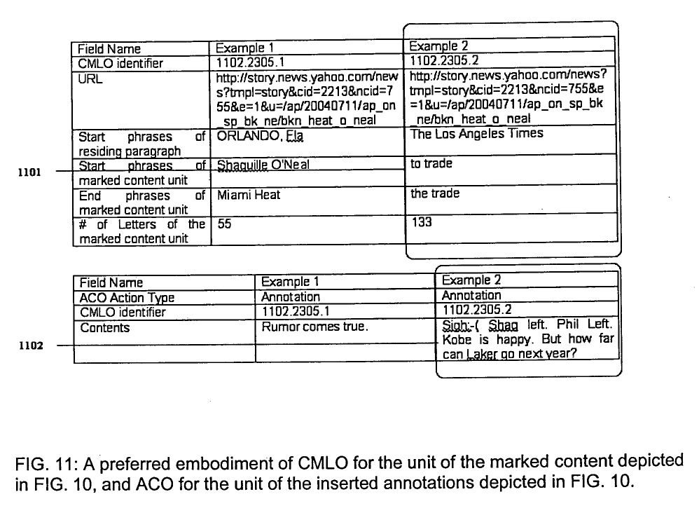

In a preferred embodiment of the invention, the hierarchical structure information of the frames and paragraphs in the frames of the web resource may be extracted and parsed and characteristics of the location and content of the unit of marked content saved. A content-matching location object (CMLO) may be operable to describe the hierarchical tree-structural location of the paragraph that the unit of marked content resides in and it's relative location information such as the number of words from the start/end word of the marked content to the start of a well-located paragraph, and characteristic content information such as the first 10 letters and last 10 letters of the marked content. FIG. 10 and FIG. 11 together illustrate an example of a preferred embodiment of the content-matching location object for a unit of marked content. A table 1101 may store two CMLOs for two marked content units 1001 shown in FIG. 10. CMLOs may be used to restore the marked content even in the situation that the web page has been modified, due to modification of the structure of frames including the addition of new frames, removal of old frames, changing contents in some sub-frames, and to the modification of online text ads. CMLOs may include in identifier, the URLs of the marked content units 1001, start phrases of a paragraph in which the marked content units 1001 reside, start phrases of the marked content units 1001, end phrases of the marked content units 1001, and the number of letters of the marked content units 1001.

A CMLO may be used to represent a unit of marked content 1001. In similar fashion an annotation content object (ACO) may be used to represent the annotation content made by the end-user associated with the unit of marked content 1001. The annotation content object may include information concerning the content of the inserted annotation and the CMLO identifier of the corresponding unit of marked content. With particular reference to FIG. 11, an ACO table 1102 may store annotation content objects associated with the inserted annotation 1002 shown in FIG. 10. ACOs may include an action type, the associated CMLO identifier and the contents of the annotation 1002.

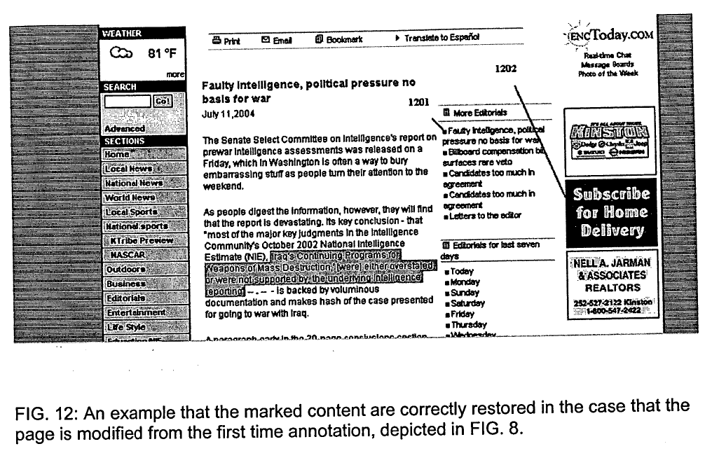

Using CMLO and ACO implementations, the marked content and associated annotation can be correctly restored, even when the web resource containing the annotated content has been modified. FIG. 12 shows an example indicating that the marked content has been correctly restored in the case where the web resource has been modified from the time of the annotation as depicted in FIG. 8. Comparing FIG. 12 to FIG. 8, a right side editorial list 1201 shown in FIG. 12 has been changed from the editorial list 821 shown in FIG. 8. Additionally, advertisements 1202 and 822 have been changed. The marked content 801 has not changed.

In accordance with another aspect of the invention, the end-user may perform several actions associated with the unit of marked content. For example, the end-user may ask for a dictionary lookup of a marked word in a dictionary, or a translation of a marked phrase, or pronunciation of a marked phrase. A platform for end-users, developers, or any third party vendors, may be provided to define, develop, and share applications associated with the marked phrases.

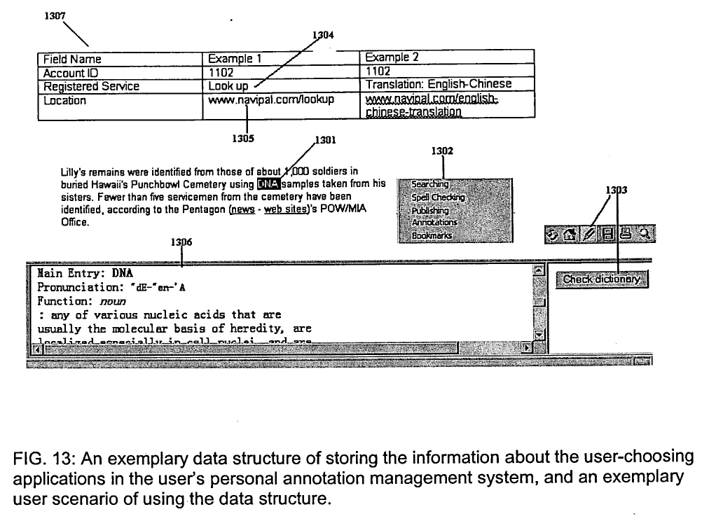

These applications may be published in a repository of applications in a public URL of the system of the invention. End-users can easily choose and integrate desired applications into their personal annotation system. The applications can be web services or downloadable .dll or .exe files. An exemplary data structure may include a table 1307 as shown in FIG. 13. Table 1307 may store information about the available applications such as the name and location of the application in the end-user's personal annotation management system. FIG. 13 also shows an exemplary user scenario including a personalized user interface with the selection buttons 1303 and menu items of a pull-down menu 1302 which menu items represent the available applications. The menu items may be retrieved from the table 1307 and shown on the user interface. A highlighting action taken with regard to the marked content 1301 and a click on the look up button 1304, or a corresponding menu item, may send a request associated with the marked content to the application link at location 1305 of the service which can be a local .exe or .dll, or a web service in nature. The application will then process the request, and return a result 1306.

The personal annotation system of the invention will manage the ACO and CMLO, reflecting the end-user's annotation behavior. The end-user may always retrieve and update his previous annotations, or the annotated page, via browsing all annotated pages in a certain category, time range, or by searching by key word or words. When the end-user finds the link to an annotated page, the end-user may click on the link and the previously marked contents and associated annotations will be correctly restored from the stored ACOs and CMLOs and shown on the screen for the end-user's review, edit and update.

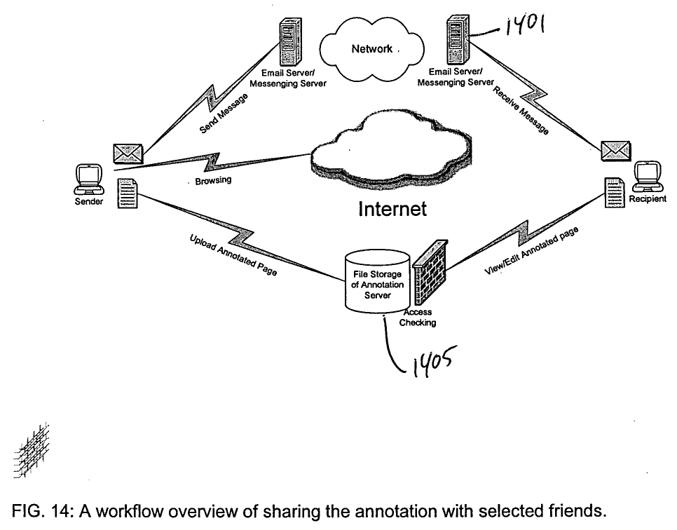

The online annotation management system and method also enable the end-users to share their annotations with peers. The end-user can share the comments/notes with his selected friends, and/or post the comments/notes publicly. The end-user may choose to expose his identity such as by revealing an account name and email address, or choose to hide his identity. The end-user may publish the annotations anonymously. FIG. 14 illustrates a workflow overview for sharing the annotation with others which comprises sending invitations to friends via an email or a messaging server 1401 and sending an access rights list with the annotated page to the annotation server 1405. The invited friend may then browse to the site to view and comment on the annotated page residing in the annotation server 1405.

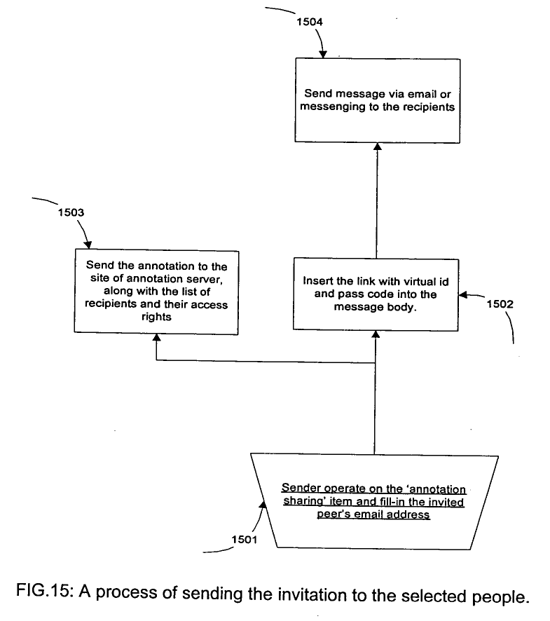

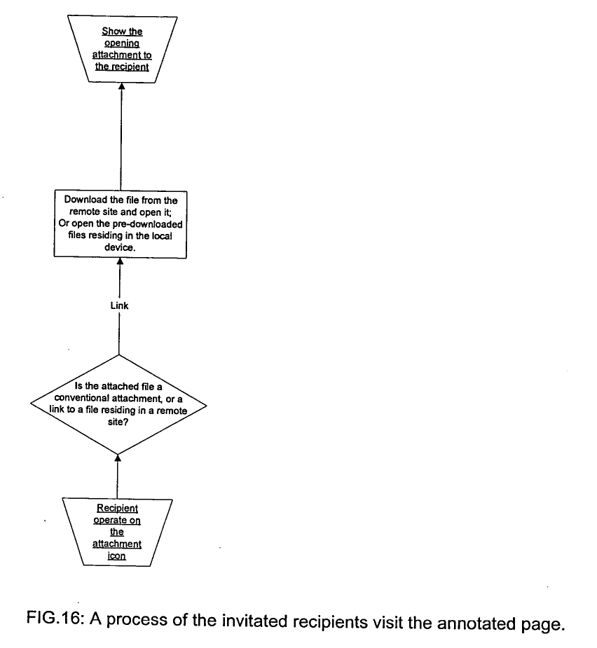

With reference to FIG.15, a process for sending an invitation to selected people is shown. When the end-user wants to share the comments with selected people, the end-user may explicitly input the email address of all the selected friends in a step 1501. In a step 1502 the end-user may send the selected friends a link to the annotated page. The link may embed the passcode/e-mail address to allow the recipients to access the annotated page. In a step 1503, the sender may also set the access rights (e.g., is the recipient authorized to create new annotations, or comment on the existent annotations, inside the page), and send the list of access rights, along with annotated page, to the annotation server 1405. The access right list may be transformed to an access rights table associated with the annotated page, determine if the identified visitor is authorized to view, or create/update, the annotations inside the annotated page. FIG.16 illustrates a process of the invited recipient visiting the annotated page. The recipient's passcode/e-mail address will first be checked with the access record table associated with the being-visited annotated page.

The online annotation management system and method of the present invention provides a system and method that allows a user to create and edit annotations The online system and method also allows the user to save and retrieve the annotations privately via a personal annotation management system. The online system and method further provides the user with options including posting the annotation publicly and sharing the annotation with peers of the user's selection regardless of whether the peers are members of the groups served by an annotation/discussion server. The online system and method also provides the user with finer retrieval control via different criteria such as keywords in the annotation, keywords in the original content, keywords in any of the user's annotations, and keywords in the annotations shared with certain groups of people. The online system and method further enables the user to easily customize the tools he wishes to use during his browsing/annotation experience and to embed these tools into the personal annotation management system. The online system and method also provides the user with an optional anonymous publishing mechanism and with an optional anonymous communication mechanism.

The foregoing description of the embodiments of the invention has been presented for the purposes of illustration and description. It is not intended to be exhaustive or to limit the invention to the precise form disclosed. Thus, while the invention has been described in terms of a PC-based browser, one skilled in the art will recognize that the invention may utilize any browser capable of browsing the Internet, including cellular telephone browsers, PDA browsers and gaming device browsers. Many modifications and variations are possible in light of the above teaching. It is intended that the scope of the invention be limited not by this detailed description, but rather by the claims appended hereto.

We claim:

1. A computer-implemented method for enabling users to create annotations during an online session comprising the steps of:
(a) providing a switch module operable to enable the user to switch between a browsing mode and an annotation mode; and
(b) providing an annotation module operable to enable the user to annotate a resource being viewed.

2. The method of claim 1, wherein the switch module is operable to enable the user to switch between the browsing mode and the annotation mode with one click of a button.

3. The method of claim 1, wherein the annotation module is operable to enable annotation by highlighting at least a portion of the resource being viewed.

4. The method of claim 1, wherein the annotation module is operable to enable annotation by inserting comments into the at least one portion of the resource being viewed.

5. The method of claim 1, wherein the switch module is a client-side plug in having a user interface.

6. The method of claim 5, wherein the user interface includes a button operable to indicate whether the user is in browser mode or in annotation mode.

7. The method of claim 1, wherein the annotation module comprises an annotation application running on an annotation server.

8. The method of claim 7, wherein the annotation application is operable to record the user's online session.

9. The method of claim 7, wherein the annotation application is operable to allow the user to manage an annotation content.

10. The method of claim 9, wherein the annotation application comprises a content-matching location object operable to represent the annotation content.

11. The method of claim 9, further comprising providing applications associated with the annotation content.

12. The method of claim 11, wherein the applications associated with the annotation content comprise a translation application.

13. The method of claim 11, wherein the applications associated with the annotation content comprise a dictionary application.

14. The method of claim 11, wherein the applications associated with the annotation content comprise a phonetic application.

15. The method of claim 11, wherein the applications associated with the annotation content are managed by the annotation application.

16. A system for enabling users to create annotations during an online session comprising:
a switch module operable to enable the user to switch between a browsing mode and an annotation mode; and
an annotation module operable to enable the user to annotate a resource being viewed.

17. The system of claim 16, wherein the annotation module is operable to allow the user to manage an annotation content

18. The system of claim 16, wherein the annotation module is operable to enable annotation by highlighting at least a portion of the resource being viewed

19. A computer readable medium comprising:
a code segment for providing a switch module operable to enable the user to switch between a browsing mode and an annotation mode; and
a code segment for providing an annotation module operable to enable the user to annotate a resource being viewed.

20. The computer readable medium of claim 19, wherein the annotation module is operable to allow the user to manage an annotation content.
